(19) United States
(12) Patent Application Publication
(10) Pub. No.: US 2005/0241587 A1
(43) Pub. Date: Nov. 3, 2005

(54) Intermittent wildlife feeder

(76) Inventors: Joseph A. Parrott, Milton, VT (US); Michael W. Chasse, South Hero, VT (US)

Correspondence Address: John W. O'Donnell, Esq.;O'Donnell Law Group PLC, PO Box 8471, Burlington, VT, 05402-8471, US

(21) Appl. No.: 10/834,475

(22) Filed: Apr. 29, 2004

(51) Int. Cl. A01K 5/01

(52) U.S. Cl. 119/51.12

(57) ABSTRACT

An automatic wildlife feeder with a retractable cover and timing device so that the feed is available to wildlife only at pre-selected times.

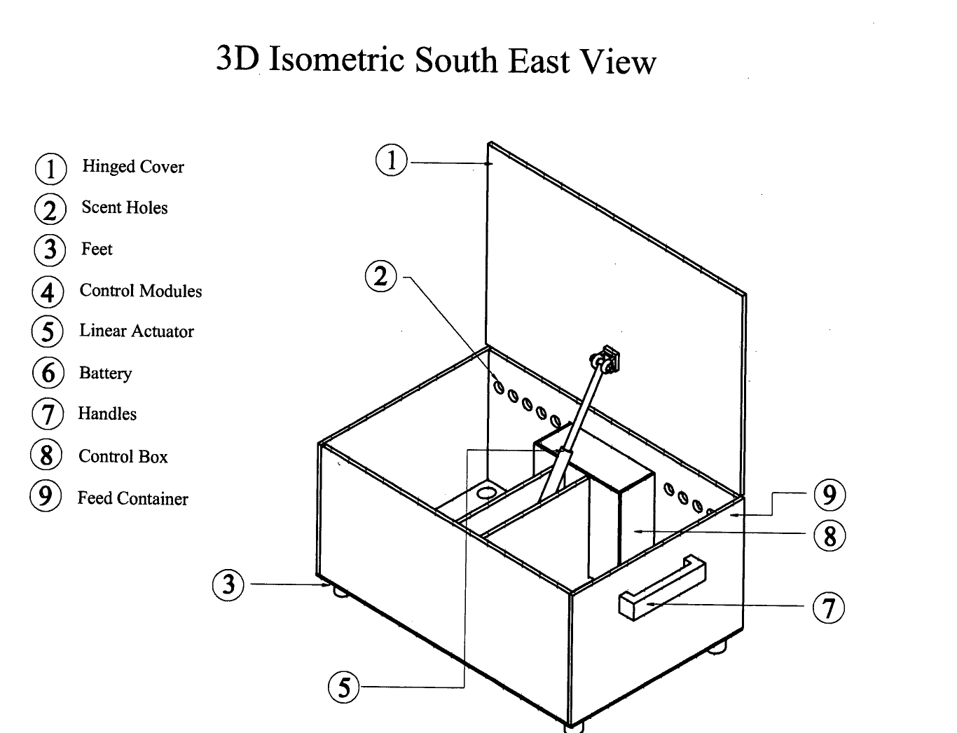

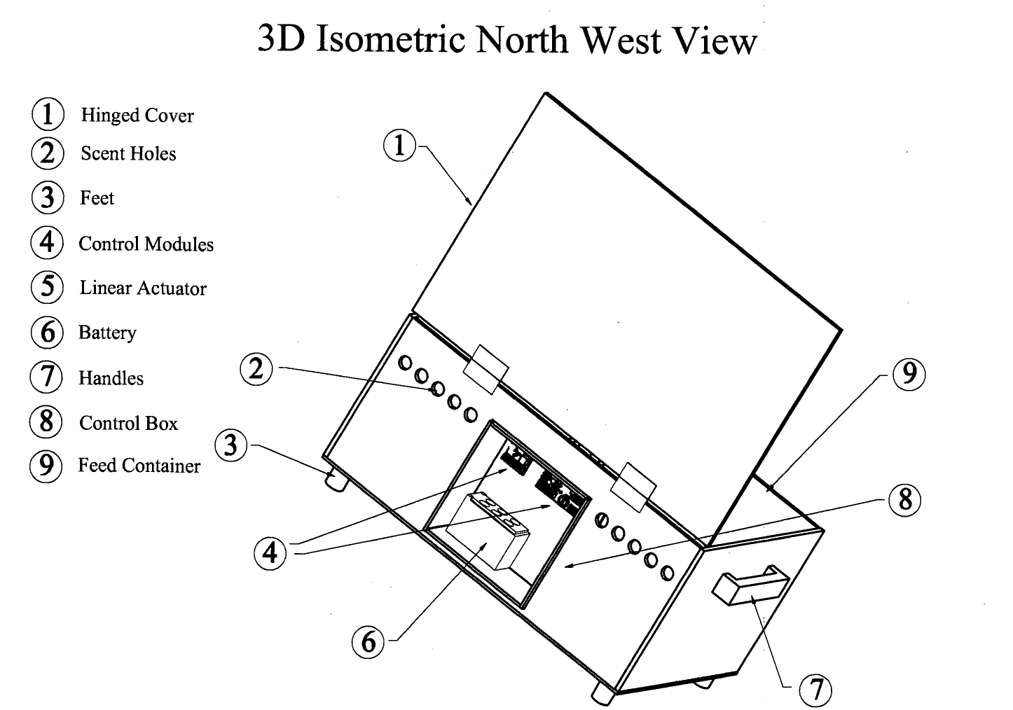

### BACKGROUND

Wildlife feeders dispense feed onto the ground to attract selected wildlife to a certain area. Simply attracting the wildlife to the area, however, is often not enough. Deer, for example, quickly learn to approach the dispensed feed only after dark or when otherwise not threatened. This invention controls the time when the feed is available to the attracted wildlife.

### DESCRIPTION OF THE INVENTION

The intermittent wildlife feeder is comprised of a receptacle with a retractable cover. Feed is contained within the receptacle. A timer is set so that the cover is only retracted at certain times preset by the operator. Wildlife has access to the feed only during the times set by the operator.

The feeder can be fabricated to resemble a tree stump, log, hay bale or other natural feature. It may be powered with a battery or a solar panel. Embodiments of the feeder may be in a range of sizes and may be mounted on support legs or a wheeled carriage. The bottom of the receptacle can be spring-loaded so that the feed is always accessible when the cover is retracted.

### DESCRIPTION OF THE DRAWING

In the embodiment shown in the drawings, the feed container (9) has a hinged cover (1) which is connected to the container by hinges and a linear actuator (5). The linear actuator is a means for opening and closing the cover and is connected to timing control modules (4) and a battery (6), both of which are located in a control box (8) located within the container. In this embodiment, the container has scent holes (2) in one panel of the container, feet (3) attached to the underside panel of the container for keeping the container off the ground, and handles (7) located on each end panel of the container for carrying the feeder.

1. A wildlife feeder comprising:
a storage means comprised of a housing having a side wall structure, bottom, and top, said top attached only to one side wall with hinges, thereby forming a retractable cover for said housing, said storage means having adequate size to store large quantities of feed;
said retractable cover of said housing connected to a means for opening and closing said retractable cover, said means for opening and closing said retractable cover further connected to said housing;
said means for opening and closing retractable cover connected to a timing device; and
said means for opening and closing retractable cover and timing device connected to a power transmitting means, so that said power transmitting means is turned on and off at pre-determined intervals to open or close said retractable cover.

2. A wildlife feeder as described in claim 1
where said power transmitting means is a battery.

3. A wildlife feeder as described in claim 1
where said power transmitting means is a solar-powered power transmitting means.

4. A wildlife feeder as described in claim 1
where said housing of the storage container contains a tray of dimensions approximately equal to the bottom of said housing, said tray for storage of feed;
said tray connected to said bottom of said housing by means for automatically adjusting the level of said tray within said housing.
